(19) United States
(12) Patent Application Publication
(10) Pub. No.: US 2018/0374013 A1
(43) Pub. Date: Dec. 27, 2018

(54) SERVICE ARCHITECTURE FOR DYNAMIC BLOCK APPOINTMENT ORCHESTRATION AND DISPLAY

(71) Applicant: MINDBODY, INC., San Luis Obispo, CA (US)

(72) Inventor: Amaya Becvar Weddle, San Luis Obispo, CA (US)

(21) Appl. No.: 15/628,957

(22) Filed: Jun. 21, 2017

(51) Int. Cl. G06Q 10/06; G06Q 10/02; G06Q 10/10

(52) U.S. Cl. CPC G06Q 10/06311; G06Q 10/1097; G06Q 10/02

(57) ABSTRACT

Methods, systems and media are provided for dynamic block appointment orchestration and display. One example method includes causing a display, in a first user interface of a first device connected to the network, of a time schedule including unrestricted user-selectable time slots. A selection by a user of at least one unrestricted time slot displayed in the schedule is received. A first booking in the schedule based on the selected time slot is created. The method includes contemporaneously causing a display, in a second user interface of a second device connected to the network, of the time schedule including at least one restricted time slot, the at least one restricted time slot corresponding to the first booking.

### TECHNICAL FIELD

The subject matter disclosed herein generally relates to the technical field of special-purpose machines that facilitate adding new features to a scheduling service, including software-configured computerized variants of such special-purpose machines and improvements to such variants, and to the technologies by which such special-purpose machines become improved compared to other special-purpose machines that facilitate adding the new features.

### BACKGROUND

The present subject matter seeks to address technical problems existing in conventional appointment scheduling and display. Conventional scheduling systems typically do not have the technical capability to display much more than open slots in a schedule. This limited ability can inhibit efficient scheduling.

### BRIEF DESCRIPTION OF THE DRAWINGS

In order to identify more easily the discussion of any particular element or act, the most significant digit or digits in a reference number refer to the figure number in which that element is first introduced.

FIG. 1 is a block diagram illustrating a networked system, according to an example embodiment.

FIG. 2 is a block diagram showing for the architectural details of a publication system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIGS. 5-8 are pictorial views of user interfaces, according to some example embodiments.

FIG. 9 is a flowchart for a method for dynamic block appointment orchestration and display, according to an example embodiment.

### DETAILED DESCRIPTION

“Carrier Signal” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“Client Device” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may use to access a network.

“Communications Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“Component” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Readable Medium” in this context refers to a component, device or other tangible media able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, eBay Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

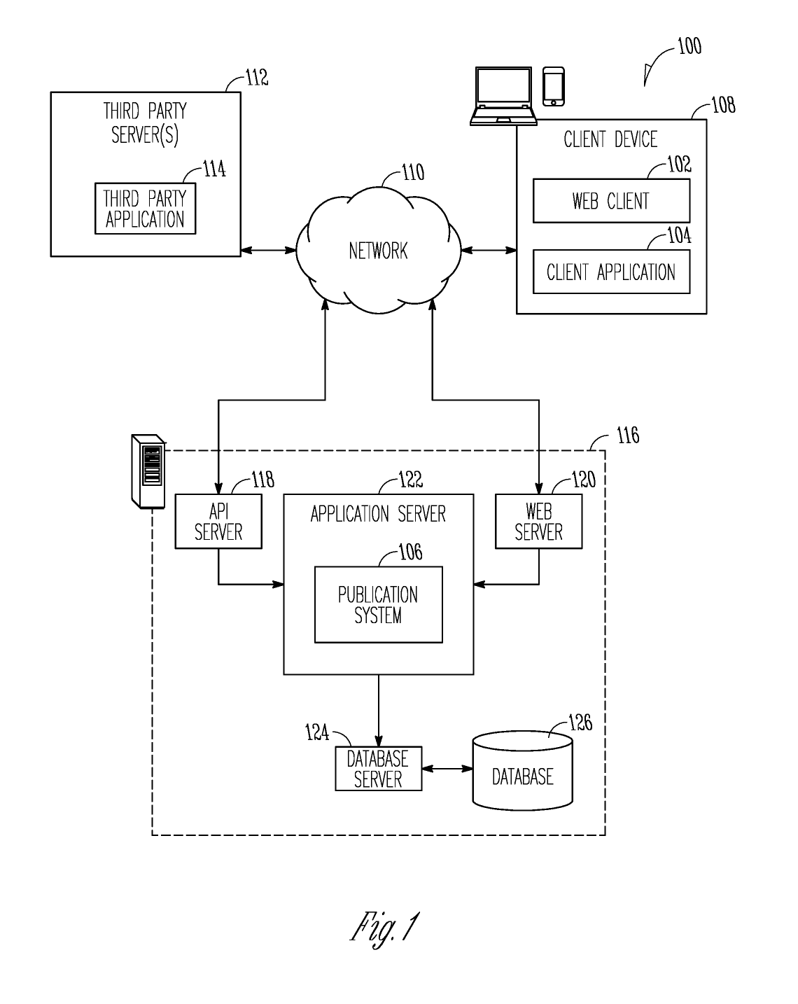

With reference to FIG. 1, an example embodiment of a high-level SaaS network architecture 100 is shown. A networked system 116 provides server-side functionality via a network 110 (e.g., the Internet or wide area network (WAN)) to a client device 108. A web client 102 and a programmatic client, in the example form of an application 104, are hosted and execute on the client device 108. The networked system 116 includes an application server 122, which in turn hosts a publication system 106 (such as the publication system hosted at mindbodyonline.com by Mindbody Inc. of San Luis Obispo, Calif.) that provides a number of functions and services to the application 104 that accesses the networked system 116. The application 104 also provides a number of interfaces described herein, which present output of the scheduling operations to a user of the client device 108.

The client device 108 enables a user to access and interact with the networked system 116, and ultimately the publication system 106. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled, and provide programmatic and web interfaces respectively, to the application server 122. The application server 122 hosts the publication system 106, which includes components or applications described further below. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on a third-party server(s) 112, is shown as having programmatic access to the networked system 116 via the programmatic interface provided by the Application Program Interface (API) server 118. For example, the third-party application 114, using information retrieved from the networked system 116, may support one or more features or functions on a website hosted by the third party.

Turning now specifically to the applications hosted by the client device 108, the web client 102 may access the various systems (e.g., publication system 106) via the web interface supported by the web server 120. Similarly, the application 104 (e.g., an “app” such as a Mindbody Inc. app) accesses the various services and functions provided by the publication system 106 via the programmatic interface provided by the Application Program Interface (API) server 118. The application 104 may be, for example, an “app” executing on a client device 108, such as an iOS or Android OS application to enable a user to access and input data on the networked system 116 in an off-line manner, and to perform batch-mode communications between the programmatic client application 104 and the networked system networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example.

The publication system 106 could also be implemented as a standalone software program, which does not necessarily have networking capabilities.

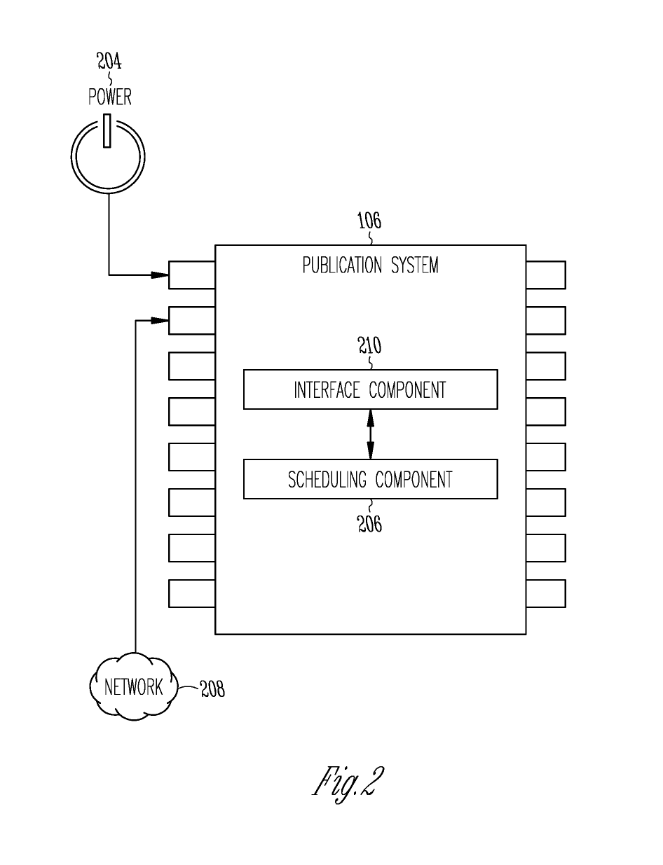

FIG. 2 is a block diagram showing architectural details of a publication system 106, according to some example embodiments. Specifically, the publication system 106 is shown to include an interface component 210 by which the publication system 106 communicates (e.g., over the network 208) with other systems within the SaaS network architecture 100.

The interface component 210 is communicatively coupled to a scheduling system (or component) 206 that operates to provide scheduling services in accordance with the methods described further below with reference to the accompanying drawings.

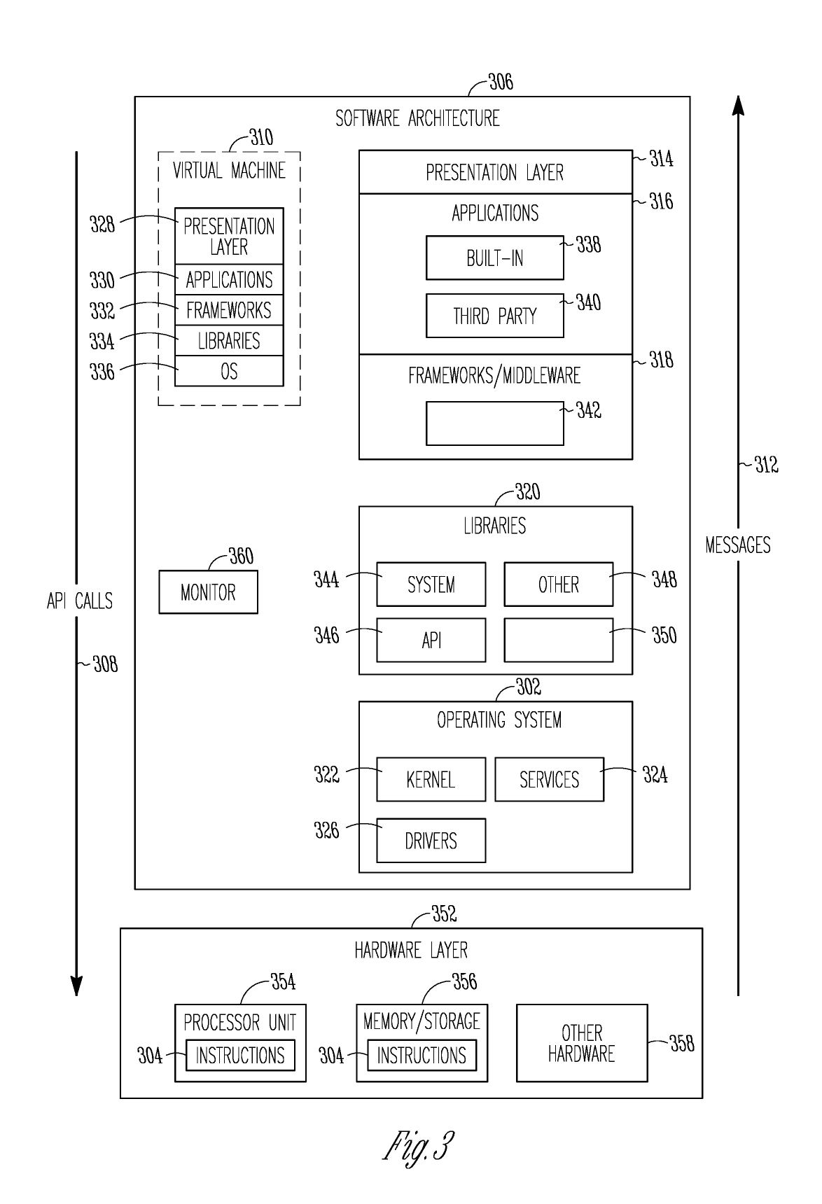

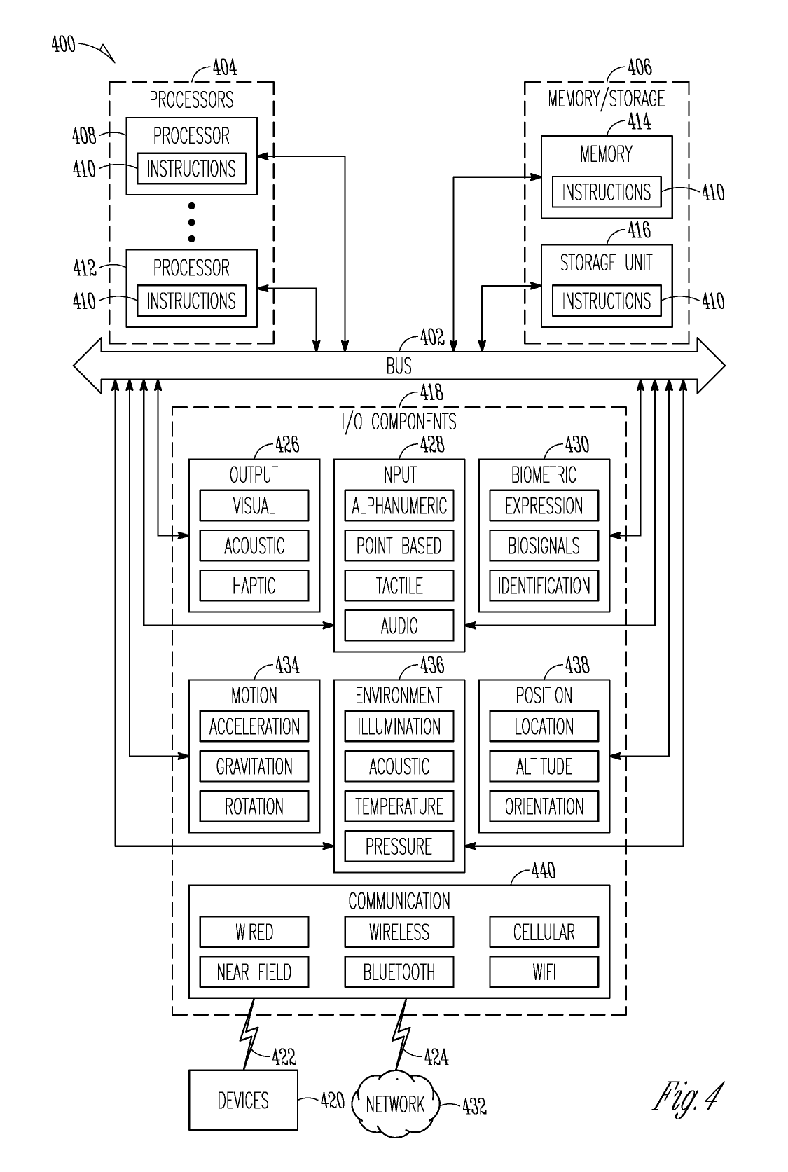

FIG. 3 is a block diagram illustrating an example software architecture 306, which may be used in conjunction with various hardware architectures herein described. FIG. 3 is a non-limiting example of a software architecture 306 and it will be appreciated that many other architectures may be implemented to facilitate the functionality described herein. The software architecture 306 may execute on hardware such as machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. Executable instructions 304 represent the executable instructions of the software architecture 306, including implementation of the methods, components and so forth described herein. The hardware layer 352 also includes memory and/or storage modules as memory/storage 356, which also have executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, applications 316 and a presentation layer 314. Operationally, the applications 316 and/or other components within the layers may invoke application programming interface (API) API calls 308 through the software stack and receive a response as messages 312 in response to the API calls 308. The layers illustrated are representative in nature and not all software architectures have all layers. For example, some mobile or special purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324 and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324 and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. Third-party applications 340 may include any application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as operating system 302) to facilitate functionality described herein.

The applications 316 may use built-in operating system functions (e.g., kernel 322, services 324 and/or drivers 326), libraries 320, and frameworks/middleware 318 to create user interfaces to interact with users of the system. Alternatively, or additionally, in some systems, interactions with a user may occur through a presentation layer, such as presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system (OS) 336 in FIG. 3) and typically, although not always, has a virtual machine monitor 360, which manages the operation of the virtual machine 310 as well as the interface with the host operating system (i.e., operating system 302). A software architecture executes within the virtual machine 310 such as an operating system (OS) 336, libraries 334, frameworks 332, applications 330 and/or presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via coupling 422 and coupling 424 respectively. For example, the communication components 440 may include a network interface component or other suitable device to interface with the network 432. In further examples, communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a Universal Serial Bus (USB)).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting a NFC beacon signal that may indicate a particular location, and so forth.

The improved technology described herein provides a scheduling system that dynamically exposes, to a user, online appointment booking time slots based on an adjacency or proximity (in time) to previous or existing booked events or appointments already in the schedule, thereby encouraging block scheduling behavior which can result in minimizing wasteful calendar openings for a service provider hosting the scheduling system. In one example, the previous or existing booked events or appointments are not displayed to the user. Instead, suggested or recommended slots only may be shown. The technical advantages provided by the scheduling system can optimize the schedule of service providers (such as small business owners) such that open time slots, when paid staff are present but not providing a service to a customer, are minimized.

In one aspect, this improved technology builds trust and encourages more businesses to expose appointment schedules to online booking more secure in the knowledge that the scheduling system will automate schedule optimization.

Conventional online booking systems simply expose a calendar of available timeslots for a service provider, without more. For example, a customer can go to an online interface in order to choose a service provider, an offering, and a timeslot for this service, then optionally book and pay for that service via a conventional e-commerce gateway.

A common problem that can occur with conventional systems is that customers do not select timeslots based on optimizing staff time at the business, but rather based on their own convenience and preference. This can lead to a reluctance on the part of the business to provide online booking, which can decrease online sales and negatively affect business valuations.

From a business perspective alone, the improved technology may encourage more providers to expose appointment books to online booking, knowing that the system can automate schedule optimization. This algorithmic schedule optimization functionality can also serve as a key differentiator for providers seeking to open up appointment scheduling APIs to third parties.

In one embodiment, a web widget can show a calendar in which initially no appointment timeslots are taken on a given day. The calendar in a web portal can expose a calendar showing an open block of time. Once a potential customer books a time slot, the system may then restrict bookings on the online calendar to times immediately before, or after, this appointment to encourage the next customer to select a timeslot or staff member that is adjacent to the previous booking. In some examples, certain appointments are driven by a dynamic pricing algorithm and “promoted” at a discounted price (set by the business), or similarly, assigned a surge price for appointments that are not optimal. Incented appointments may have a different visual UI to incentivize a consumer to book at those optimal times versus at a time that is less ideal for the business.

A provider enabling the scheduling system can set parameters such as time windows between appointments (e.g. 15 or 30 minute increments for prep and clean up time), available or preferred blocks during the day, available or preferred staff during timeslots, available or preferred resources or rooms, and available or preferred services/offerings

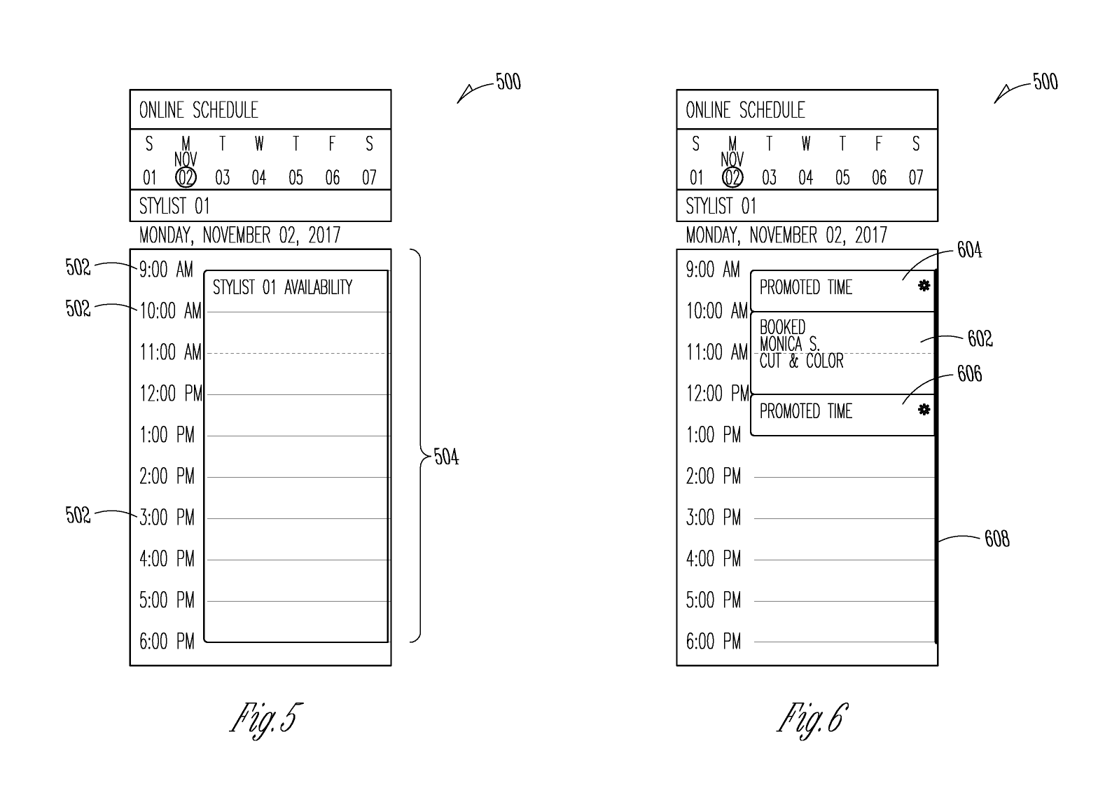

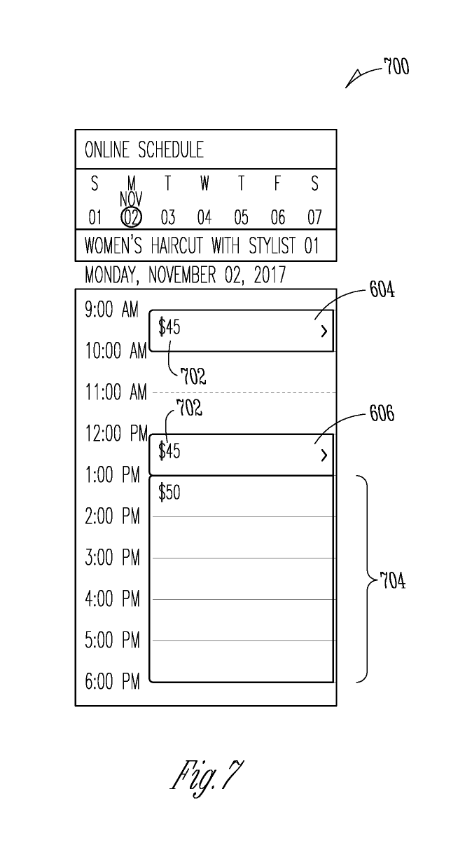

Reference is now made to FIGS. 5-6 which show, in this example, a provider's view of an interface in a scheduling system according to the present disclosure. The interface 500 in FIG. 5 may be an interactive user interface provided in the display of a device, for example, client device 108 in FIG. 1. The interface 500 includes a view of a virtual diary page in which open time slots 502 are visible. In this example, the open time slots are provided on an hourly basis and run from 9 a.m. to 6 p.m. in this example view. Other time slot durations are possible. The shaded portion 504 in the virtual diary page represents a number of open time slots in an extended period of service availability at the provider. Thus far, such a view may be typical of one given in a conventional scheduling system for which a provider may be forced to support by employing full-time staff during the entire period of open availability. The present system provides technology to assist with this.

Turning now to FIG. 6, the interface 500 is again visible but in this case a shaded portion representing a booking made by a customer (external user) is visible at 602. In this example, the booking 602 runs from 10 a.m. to 12 p.m. Immediately adjacent before and after this booking 602 are other open time slots shown by shaded portions 604 and 606, respectively. The time slots 604 and 606 may be adjacent to an existing booking, as shown, or at a time distance away, either before or after the existing booking 602. The open time slots 604 and 606 may be promoted time slots (for example, associated with a provider discount or otherwise incented for a booking) and are rendered visible to the customer as described just below. A scheduling indicator in the form, for example, of a vertical line 608 corresponds to the open portion 504 in FIG. 5, but may also represent pictorially a staff schedule, hours of operation, or other scheduling aspect, for example. In this example, the line 608 represents a time period from 9 a.m. to 6 p.m. when staff are potentially available to provide services to the customer.

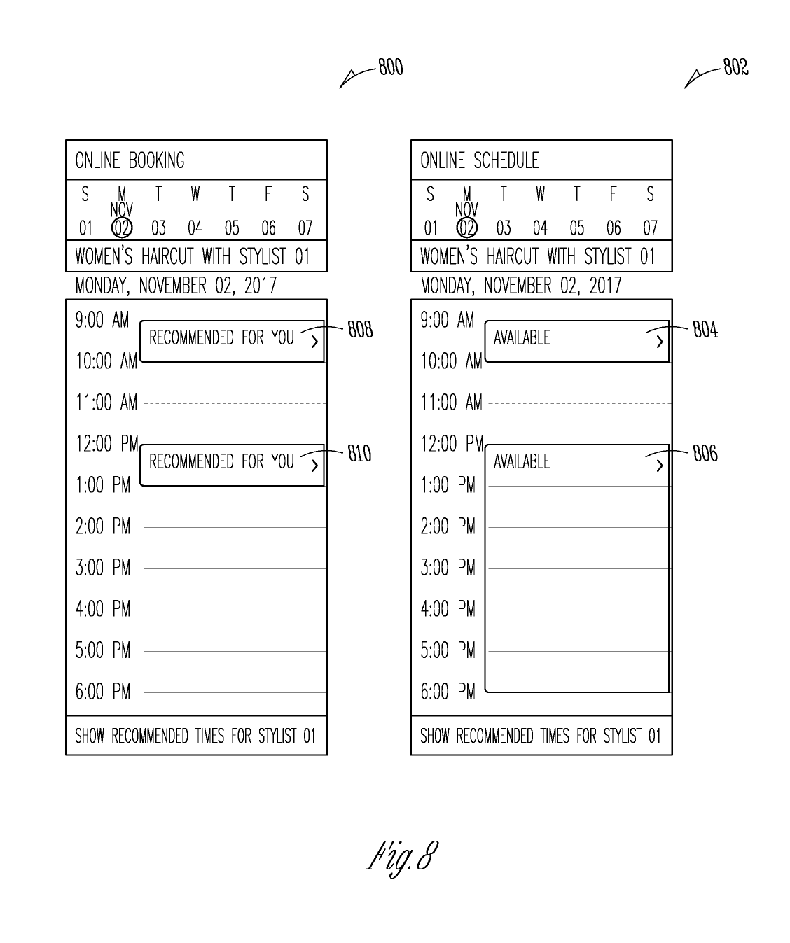

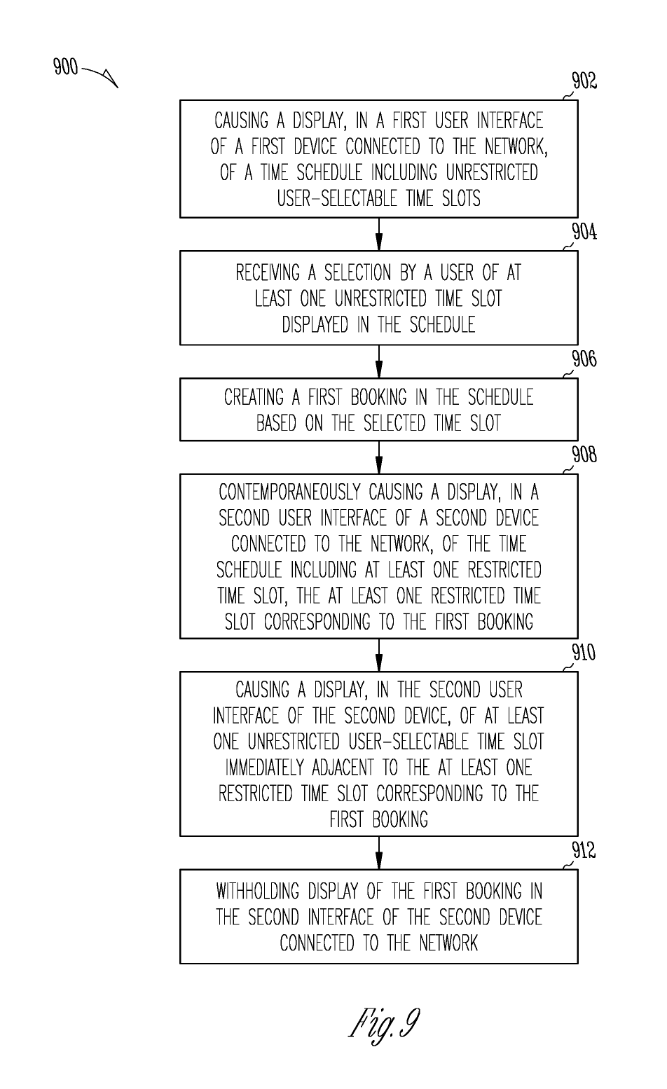

Reference is now made to FIGS. 7-8 which show, again in this example, a customer's view of an interface in a scheduling system according to the present disclosure. The interface 700 in FIG. 7, like interface 500 in FIG. 6, also shows a view of a virtual diary page, but here only the open time slots 604 and 606 are visible. Promotional service pricing may be associated with these time slots to incent the customer to take one of them as they are adjacent (timewise) to existing booking 602 shown in FIG. 6. A price of $45 (shown at 702) is associated with each time slot 604 and 606. On the other hand, a higher (or standard) service price of $50 is associated with the open period 704 which corresponds with a portion of line 608 and here represents a time period from 1 p.m. to 6 p.m. when staff are potentially available to provide services to the customer, but which could otherwise be released if one of the time slots 604 and 606 is taken. Time slots displayed in the diary page may leverage discounted or dynamic pricing to promote times that are adjacent (or a selected time distance away) from an existing booking. Blocks of time may be promoted may be promoted based on a service or provider selected.

Reference is now made to FIG. 8 which shows two customer views 800 and 802 which may each be toggled from one to another in a display. In the virtual dairy page shown in view 802, a narrow open time slot 804 and wide time slot 806 are visible to a customer, and simply indicated in this view as “Available”. Of significance to the provider is that these time slots are provided adjacent the invisible existing time entry 602 which is nonetheless visible to the provider in provider-side interface 500 in FIG. 6. The time slots corresponding to the existing booking in FIG. 8 are not marked as “Available” to a customer. A customer is incented to take narrow time slots 808 and 810 immediately adjacent each side of the existing booking 602 by toggling to view 800. In this view, the pair of narrow time slots 808 and 810 are each marked “Recommended for You” and may be associated with promotional pricing or a discount as above.

The improved technology of the present scheduling system thus provides a service architecture for dynamic block appointment orchestration and display. A special-purpose machines is provided that facilitates adding new features to a scheduling service, including software-configured computerized variants of such special-purpose machines and improvements to such variants, and to the technologies by which such special-purpose machines are improved compared to other special-purpose machines that facilitate adding the new features.

Thus, in some embodiments, there is provided a scheduling system for dynamic block appointment orchestration and display, the scheduling system comprising a network; processors; and a memory storing instructions that, when executed by at least one processor among the processors, cause the scheduling system to perform operations comprising, at least causing a display, in a first user interface of a first device connected to the network, of a time schedule including unrestricted user-selectable time slots; receiving a selection by a user of at least one unrestricted time slot displayed in the schedule; creating a first booking in the schedule based on the selected time slot; contemporaneously causing a display, in a second user interface of a second device connected to the network, of the time schedule including at least one restricted time slot, the at least one restricted time slot corresponding to the first booking.

In some examples, the operations may further comprise causing a display, in the second user interface of the second device, of at least one unrestricted user-selectable time slot immediately adjacent to the at least one restricted time slot corresponding to the first booking. In some further examples, the operations may further comprise withholding display of the first booking in the second interface of the second device connected to the network.

Still further, the operations may further comprise receiving a selection by a user of the at least one unrestricted user-selectable time slot immediately adjacent to the at least one restricted time slot corresponding to the first booking; creating a second booking in the schedule based on the selected time slot adjacent to the at least one restricted time slot; creating a composite block booking in the schedule based on the first booking, and the second booking; causing a display, in the first user interface of the first device connected to the network, of the composite block booking; and assigning a restricted status to the composite block booking.

In some examples, the operations further comprise withholding display of the composite block booking in a third interface of a third device connected to the network. The operations may also comprise associating a booking incentive with the at least one unrestricted user-selectable time slot immediately adjacent to the at least one restricted time slot corresponding to the first booking.

Some embodiments of the present inventive subject matter include methods for dynamic block appointment orchestration and display. A flow diagram for one example method 900 is illustrated in FIG. 9. The method 900 includes, at block 902, causing a display, in a first user interface of a first device connected to the network, of a time schedule including unrestricted user-selectable time slots; at block 904, receiving a selection by a user of at least one unrestricted time slot displayed in the schedule; at block 906, creating a first booking in the schedule based on the selected time slot; at block 908, contemporaneously causing a display, in a second user interface of a second device connected to the network, of the time schedule including at least one restricted time slot, the at least one restricted time slot corresponding to the first booking.

The method 900 may further comprise, at block 910, causing a display, in the second user interface of the second device, of at least one unrestricted user-selectable time slot immediately adjacent to the at least one restricted time slot corresponding to the first booking. At block 912, the method 900 may further comprise withholding display of the first booking in the second interface of the second device connected to the network.

In further examples, the method 900 may further comprise receiving a selection by a user of the at least one unrestricted user-selectable time slot immediately adjacent to the at least one restricted time slot corresponding to the first booking; creating a second booking in the schedule based on the selected time slot adjacent to the at least one restricted time slot; creating a composite block booking in the schedule based on the first booking, and the second booking; causing a display, in the first user interface of the first device connected to the network, of the composite block booking; and assigning a restricted status to the composite block booking. Further, the method 900 may comprise withholding display of the composite block booking in a third interface of a third device connected to the network. Still further, the method 900 may comprise associating a booking incentive with the at least one unrestricted user-selectable time slot immediately adjacent to the at least one restricted time slot corresponding to the first booking.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A scheduling system for dynamic block appointment orchestration and display, the scheduling system comprising:
a network;
processors; and
a memory storing instructions that, when executed by at least one processor among the processors, cause the scheduling system to perform operations comprising, at least:
causing a display, in a first user interface of a first device connected to the network, of a time schedule including unrestricted user-selectable time slots;
receiving a selection by a user of at least one unrestricted time slot displayed in the schedule;
creating a first booking in the schedule based on the selected time slot;
contemporaneously causing a display, in a second user interface of a second device connected to the network, of the time schedule including at least one restricted time slot, the at least one restricted time slot corresponding to the first booking.

2. The scheduling system of claim 1, wherein the operations further comprise:
causing a display, in the second user interface of the second device, of at least one unrestricted user-selectable time slot immediately adjacent to the at least one restricted time slot corresponding to the first booking.

3. The scheduling system of claim 1, wherein the operations further comprise withholding display of the first booking in the second interface of the second device connected to the network.

4. The scheduling system of claim 2, wherein the operations further comprise:
receiving a selection by a user of the at least one unrestricted user-selectable time slot immediately adjacent to the at least one restricted time slot corresponding to the first booking;
creating a second booking in the schedule based on the selected time slot adjacent to the at least one restricted time slot;
creating a composite block booking in the schedule based on the first booking, and the second booking;
causing a display, in the first user interface of the first device connected to the network, of the composite block booking; and
assigning a restricted status to the composite block booking.

5. The scheduling system of claim 4, wherein the operations further comprise withholding display of the composite block booking in a third interface of a third device connected to the network.

6. The scheduling system of claim 1, wherein the operations further comprise associating a booking incentive with the at least one unrestricted user-selectable time slot immediately adjacent to the at least one restricted time slot corresponding to the first booking.

7. A computer-implemented method for dynamic block appointment orchestration and display, the method comprising:
causing a display, in a first user interface of a first device connected to the network, of a time schedule including unrestricted user-selectable time slots;
receiving a selection by a user of at least one unrestricted time slot displayed in the schedule;
creating a first booking in the schedule based on the selected time slot;
contemporaneously causing a display, in a second user interface of a second device connected to the network, of the time schedule including at least one restricted time slot, the at least one restricted time slot corresponding to the first booking.

8. The method of claim 7, further comprising:
causing a display, in the second user interface of the second device, of at least one unrestricted user-selectable time slot immediately adjacent to the at least one restricted time slot corresponding to the first booking.

9. The method of claim 1, further comprising withholding display of the first booking in the second interface of the second device connected to the network.

10. The method of claim 6, further comprising:
receiving a selection by a user of the at least one unrestricted user-selectable time slot immediately adjacent to the at least one restricted time slot corresponding to the first booking;
creating a second booking in the schedule based on the selected time slot adjacent to the at least one restricted time slot;
creating a composite block booking in the schedule based on the first booking, and the second booking;
causing a display, in the first user interface of the first device connected to the network, of the composite block booking; and
assigning a restricted status to the composite block booking.

11. The method of claim 10, further comprising withholding display of the composite block booking in a third interface of a third device connected to the network.

12. The method of claim 7, further comprising associating a booking incentive with the at least one unrestricted user-selectable time slot immediately adjacent to the at least one restricted time slot corresponding to the first booking.

13. A non-transitory machine-readable medium comprising instructions which, when read by a machine, cause the machine to perform operations for dynamic block appointment orchestration and display, the operations comprising, at least:
causing a display, in a first user interface of a first device connected to the network, of a time schedule including unrestricted user-selectable time slots;
receiving a selection by a user of at least one unrestricted time slot displayed in the schedule;
creating a first booking in the schedule based on the selected time slot;
contemporaneously causing a display, in a second user interface of a second device connected to the network, of the time schedule including at least one restricted time slot, the at least one restricted time slot corresponding to the first booking.

14. The medium of claim 13, wherein the operations further comprise:
causing a display, in the second user interface of the second device, of at least one unrestricted user-selectable time slot immediately adjacent to the at least one restricted time slot corresponding to the first booking.

15. The medium of claim 13, wherein the operations further comprise withholding display of the first booking in the second interface of the second device connected to the network.

16. The medium of claim 14, wherein the operations further comprise:
receiving a selection by a user of the at least one unrestricted user-selectable time slot immediately adjacent to the at least one restricted time slot corresponding to the first booking;
creating a second booking in the schedule based on the selected time slot adjacent to the at least one restricted time slot;
creating a composite block booking in the schedule based on the first booking, and the second booking;
causing a display, in the first user interface of the first device connected to the network, of the composite block booking; and
assigning a restricted status to the composite block booking.

17. The medium of claim 16, wherein the operations further comprise withholding display of the composite block booking in a third interface of a third device connected to the network.

18. The medium of claim 13, wherein the operations further comprise associating a booking incentive with the at least one unrestricted user-selectable time slot immediately adjacent to the at least one restricted time slot corresponding to the first booking.
